(19) United States
(12) Patent Application Publication
(10) Pub. No.: US 2018/0328420 A1
(43) Pub. Date: Nov. 15, 2018

(54) OPERATION CONTROL DEVICE AND OPERATION CONTROL METHOD OF DIRECT CONTROL SOLENOID VALVE

(71) Applicants: HYUNDAI MOTOR COMPANY, Seoul (KR); KIA MOTORS CORPORATION, Seoul (KR)

(72) Inventors: Jung Wan CHOI, Gwangmyeong-si (KR); Jungwoo Seo, Hwaseong-si (KR); Yun Ho Choi, Gunpo-si (KR); Yoh Han Kim, Seoul (KR)

(73) Assignees: HYUNDAI MOTOR COMPANY, Seoul (KR); KIA MOTORS CORPORATION, Seoul (KR)

(21) Appl. No.: 15/830,598

(22) Filed: Dec. 4, 2017

(30) Foreign Application Priority Data
May 15, 2017 (KR) 10-2017-0059785

(51) Int. Cl. F16D 48/02; G05D 16/20; F16K 31/06; F16K 11/07

(52) U.S. Cl. CPC F16D 48/02; G05D 16/2033; F16D 2048/0221; F16K 11/07; F16D 25/14; F16K 31/0675

(57) ABSTRACT

The present disclosure provides an operation control apparatus of a direct control solenoid valve. The apparatus includes a direct control solenoid valve configured to control an operation of a clutch via a control pressure and to supply the control pressure to a clutch by magnetic force generated by a current control; and a hydraulic pressure supply valve configured to supply a hydraulic pressure to the direct control solenoid valve, wherein the hydraulic pressure supply valve is operatively associated with a clutch control.

### CROSS-REFERENCE TO RELATED APPLICATION

The present application claims priority to and the benefit of Korean Patent Application No. 10-2017-0059785, filed on May 15, 2017, which is incorporated herein by reference in its entirety.

### FIELD

The present disclosure relates to an operation control device of a direct control solenoid valve and an operation control method using the same.

### BACKGROUND

The statements in this section merely provide background information related to the present disclosure and may not constitute prior art.

Recently, a direct control solenoid valve for directly controlling a hydraulic pressure without use of a pilot valve has been used to improve shift feel and reduce a weight of a transmission.

A solenoid valve controls a pilot valve to directly control a hydraulic pressure without control of a hydraulic pressure, thereby improving responsiveness. In addition, a plurality of valves are integrated into one element to reduce risk and to reduce required flow of an oil pump, thereby enhancing fuel efficiency.

FIG. 1 is a diagram showing a direct control solenoid valve in a prior art. FIG. 2 is a graph showing a control pressure of the direct control solenoid valve of FIG. 1.

Referring to FIGS. 1 and 2, valve operating force of the conventional direct control solenoid valve may be determined by only magnetic force (FMAG.). However, the conventional direct control solenoid valve may have the limited turn number of a magnetic portion and, thus, magnetic force for determining the valve operating force may be limited.

That is, since the valve operating force of the conventional direct control solenoid valve is limited, amplitude of an actually discharged control pressure cannot satisfy a target pressure and, thus, responsiveness of the valve may be lowered. Also, the conventional direct control solenoid valve has a high sensitivity of a clutch via an operation of a valve to negatively affect controllability.

Accordingly, to enhance responsiveness of a valve or control sensitivity, a turn number of a magnetic portion may be desired to increase magnetic force or a volume of the valve. As a result, the associated costs may increase and it may affect installation characteristics.

The above information disclosed in this section is only for enhancement of understanding of the background of the disclosure and therefore it may contain information that does not form the prior art that is already known in this country to a person of ordinary skill in the art.

### SUMMARY

The present disclosure provides an operation control device and operation control method of a direct control solenoid valve with an increased valve operating force and enhanced responsiveness of a valve, which may be achieved without the increase of a volume of a valve.

One form of the present disclosure provides an operation control apparatus of a direct control solenoid valve, the apparatus including: a direct control solenoid valve configured to control an operation of a clutch via a control pressure and to supply the control pressure to a clutch by magnetic force generated by a current control, and a hydraulic pressure supply valve configured to supply a hydraulic pressure to the direct control solenoid valve, wherein the hydraulic pressure supply valve is operatively associated with a clutch control.

The apparatus may further include a switch valve configured to feedback the control pressure and to provide a feedback pressure to the direct control solenoid valve.

The direct control solenoid valve may include first and second valve members operated by valve operating force from the magnetic force, a control pressure supply port configured to receive a control pressure by an operation of the second valve member, wherein the second valve member is configured to open the control pressure supply port, and a control pressure exhaust port configured to supply the control pressure to the clutch.

The direct control solenoid valve may further include a first hydraulic pressure supply port configured to receive a hydraulic pressure by the hydraulic pressure supply valve and to increase the valve operating force from the magnetic force.

The direct control solenoid valve may further include a feedback input port configured to receive a feedback pressure from the switching valve.

The switching valve may include a second hydraulic pressure supply port configured to receive a hydraulic pressure by the hydraulic pressure supply valve, and a third valve member configured to operate by a hydraulic pressure that is supplied to the second hydraulic pressure supply port.

The switching valve may include: a feedback input port configured to receive a control pressure supplied from the direct control solenoid valve, wherein the third valve member is configured to open the feedback input port; and a feedback output port configured to feedback the control pressure to the direct control solenoid valve.

The apparatus may further include a controller configured to control an operation of the direct control solenoid valve, an operation of the hydraulic pressure supply valve, and an operation of the switching valve.

Another form of the present disclosure provides a method of controlling an operation of a direct control solenoid valve by an operation control apparatus of a direct control solenoid valve for controlling an operation of a clutch, the method including: operating a hydraulic pressure supply valve, supplying current to the direct control solenoid valve and increasing magnetic force to operate a clutch, and, when clutch control completes, turning off the hydraulic pressure supply valve.

Operating the hydraulic pressure supply valve may include, standing by to supply a hydraulic pressure to the direct control solenoid valve and a switching valve.

Increasing the magnetic force may include increasing valve operating force from the magnetic force by a hydraulic pressure supplied to the hydraulic pressure supply valve.

Increasing the magnetic force may further include, when a control pressure exhausted to the clutch from the direct control solenoid valve is equal to or greater than a predetermined value, feeding back the control pressure to the direct control solenoid valve through the switching valve.

Turning off the hydraulic pressure supply valve may include blocking a hydraulic pressure supplied to the direct control solenoid valve and to the switching valve.

In some forms of the present disclosure, the operation control apparatus of the direct control solenoid valve may supply a hydraulic pressure to a direct control solenoid valve and a switching valve through a hydraulic pressure supply valve and may combine valve operating force from magnetic force and valve operating force from a hydraulic pressure of the hydraulic pressure supply valve to provide an environment for increasing valve operating force and for improving responsiveness of a valve without increase in a volume of the valve for increasing magnetic force.

The present disclosure may feedback a control pressure exhausted from a direct control solenoid valve to the direct control solenoid valve through a switching valve to provide an environment for remarkably enhancing the sensitivity of a change in a control pressure with respect to a current change and for improving clutch control performance.

In addition, the present disclosure may increase an area, to which a feedback pressure fed back from a switching valve is applied, by increasing valve operating force to provide an environment for enhancing responsiveness of a valve.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram showing a configuration of a direct control solenoid valve according to a prior art;

FIG. 2 is a graph showing a control pressure of the direct control solenoid valve of FIG. 1;

FIG. 3 is a diagram showing a standby state before an operation control apparatus of a direct control solenoid valve controls a clutch;

FIG. 4 is a diagram showing a clutch control state of an operation control apparatus of a direct control solenoid valve;

FIG. 5 is a diagram showing a clutch control completion state of an operation control apparatus of a direct control solenoid valve;

FIG. 6 is a schematic flowchart of an operation of controlling an operation of a direct control solenoid valve;

FIG. 7 is a graph showing a control pressure of an operation control apparatus of a direct control solenoid valve; and

FIG. 8 is a graph showing a relationship between current and a hydraulic pressure by an operation of a direct control solenoid valve.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Some forms of the present disclosure are described in detail so as for those of ordinary skill in the art to easily implement with reference to the accompanying drawings. However, the present disclosure may be implemented in various different forms and is not limited to these forms.

Throughout this specification, unless explicitly described to the contrary, the word “comprise” and variations such as “comprises” or “comprising”, will be understood to imply the inclusion of stated elements but not the exclusion of any other elements.

Throughout this specification, like reference numerals in the specification denote like elements.

The terms “vehicle”, “car”, “of vehicle”, “vehicle” or other similar terms used in the specification include sports utility vehicles (SUVs), a bus, a truck, a passenger vehicle including various commercial vehicles, a ship including various types of boats or vessels, an airplane, and a vehicle including a similar device and includes a hybrid vehicle, an electric vehicle, a plug in hybrid electric vehicle, a hydrogen fuel vehicle, and other replaceable fuel (e.g., fuel obtained from resources other than petroleum) vehicles.

In addition, some methods may be performed by at least one controller. The term “controller” may refer to a hardware device including a memory and a processor for performing one operation or more interpreted as an algorithm structure. The memory may store algorithm operations and the processor may particularly perform the algorithm operations to perform at least one of the below-described processes.

In addition, a control logic according to the present disclosure may be implemented as a non-transitory computer readable medium on a computer readable device including executable program commands executed by a processor, a controller, or a similar device. Examples of the computer readable device include, but are not limited to, read-only memory (ROM), random-access memory (RAM), CD-ROM, a magnetic tape, a floppy disk, a flash drive, a smart card, and an optical data storage device. A computer readable reproduction medium is distributed over network coupled computer systems to be stored and executed in a distribution fashion, for example, by a telematics server or a controller area network (CAN).

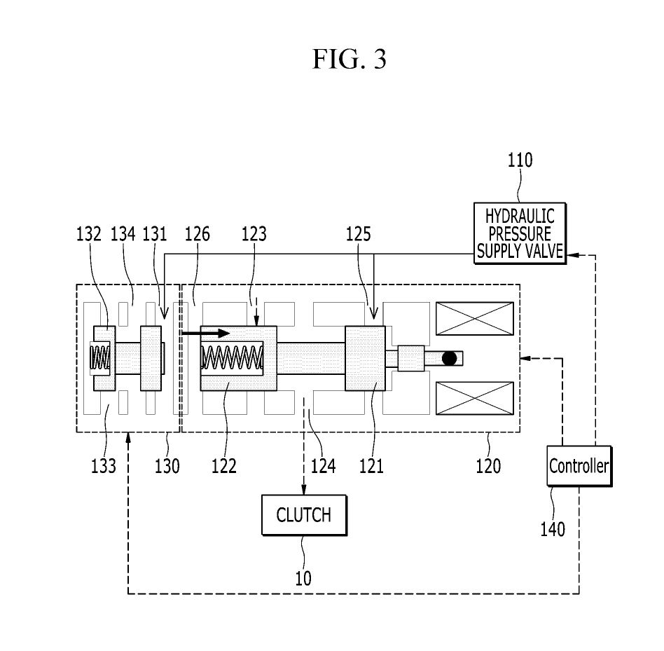

Hereinafter, with reference to FIGS. 3 to 8, an operation control apparatus and method of a direct control solenoid valve in some forms of the present disclosure will be described in detail.

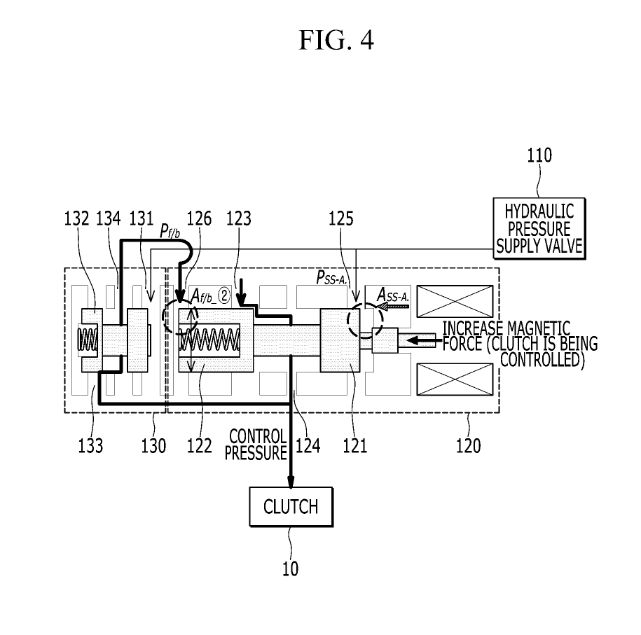

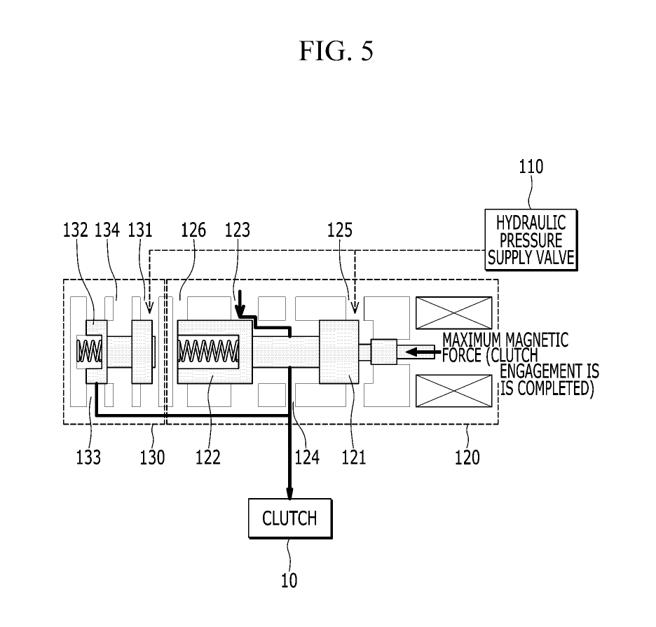

FIG. 3 is a diagram showing a standby state before an operation control apparatus of a direct control solenoid valve controls a clutch in some forms of the present disclosure. FIG. 4 is a diagram showing a clutch control state of an operation control apparatus of a direct control solenoid valve in some forms of the present disclosure. FIG. 5 is a diagram showing a clutch control completion state of an operation control apparatus of a direct control solenoid valve in some forms of the present disclosure. In this case, only a schematic configuration that is required to explain forms of the present disclosure will be described and, thus, the operation control apparatus of the direct control solenoid valve is not limited thereto.

Referring to FIG. 3 to FIG. 5, the operation control apparatus of the direct control solenoid valve in some forms of the present disclosure may include a hydraulic pressure supply valve 110 that is operatively associated with a clutch control, a direct control solenoid valve 120 for controlling an operation of a clutch 10 through a control pressure, a switching valve 130 for feeding back the control pressure and providing the feedback pressure to the direct control solenoid valve 120, and a controller 140 for controlling operations of a valve and a clutch.

The hydraulic pressure supply valve 110 may include an on/off solenoid valve (SS-A) that is operatively associated with clutch control as a reversing valve to adjust a lubrication amount. The hydraulic pressure supply valve 110 may supply a hydraulic pressure of a hydraulic pressure line to the direct control solenoid valve 120 and the switching valve 130 before controlling the direct control solenoid valve 120.

The direct control solenoid valve 120 may supply the control pressure to the clutch 10 by magnetic force according to current control of the controller 140.

The direct control solenoid valve 120 may include a first valve member 121 and a second valve member 122, operated by a valve operating force using the magnetic force, a control pressure supply port 123 that is opened by an operation of the second valve member 122 for receiving a control pressure, a control pressure exhaust port 124 for supplying the control pressure to the clutch, a first hydraulic pressure supply port 125 for receiving a hydraulic pressure of the hydraulic pressure supply valve 110 and increasing valve operating force via the magnetic force, and a feedback input port 126 for receiving the feedback pressure from the switching valve 130.

The switching valve 130 may be coupled to one side of the direct control solenoid valve 120 and may feedback a control pressure exhausted from the direct control solenoid valve 120 to provide the control pressure to the direct control solenoid valve 120. The switching valve 130 may be operated to provide a feedback pressure to the direct control solenoid valve 120 when the control pressure is a predetermined value or more.

The switching valve 130 may include a second hydraulic pressure supply port 131 for receiving a hydraulic pressure of the hydraulic pressure supply valve 110, a third valve member 132 operated according to a hydraulic pressure input to the second hydraulic pressure supply port 131 or control of the controller 140, a feedback input port 133 that is opened by an operation of the third valve member 132 to receive a control pressure exhausted from the direct control solenoid valve 120, and a feedback output port 134 that feeds back the control pressure input to the feedback input port 133 to the direct control solenoid valve 120.

The controller 140 may control an operation of the hydraulic pressure supply valve 110, the direct control solenoid valve 120, or the switching valve 130.

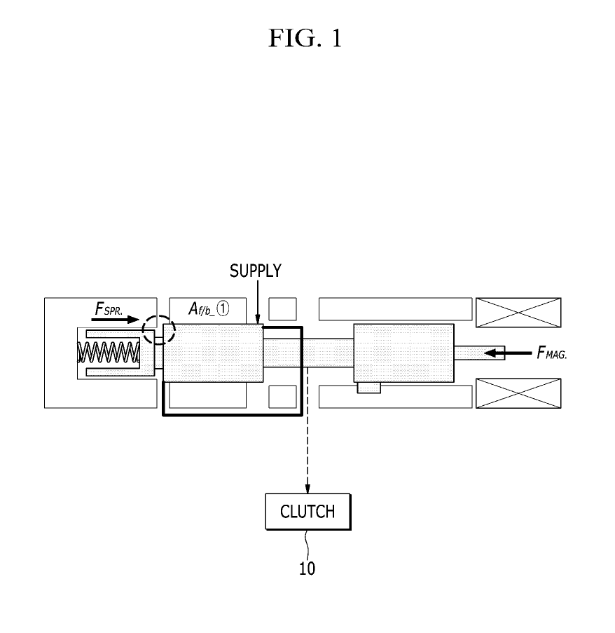

As shown in FIG. 1, the controller 140 may turn on the hydraulic pressure supply valve 110 before controlling a clutch and may be on standby to supply a hydraulic pressure to the direct control solenoid valve 120 and the switching valve 130.

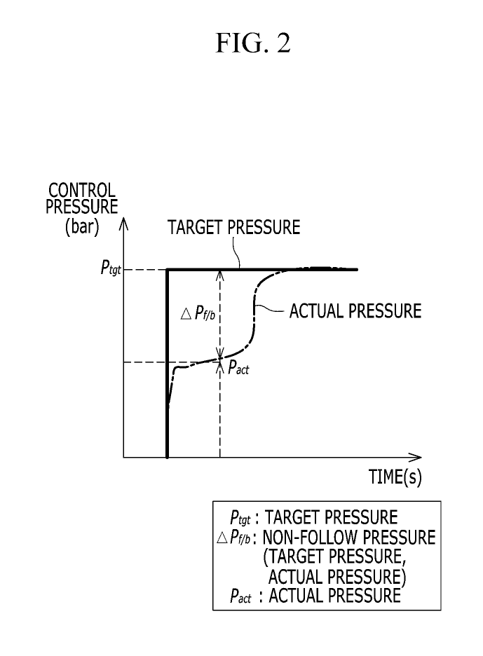

As shown in FIG. 2, the controller 140 may increase magnetic force of the direct control solenoid valve 120 via current control and may operate the first valve member 121 and the second valve member 122 to control the clutch 10.

In this case, the first hydraulic pressure supply port 125 may be opened by an operation of the first valve member 121 and a hydraulic pressure of the hydraulic pressure supply valve 110 may be input to the first hydraulic pressure supply port 125. The hydraulic pressure (P_{SS-A}) input to the first hydraulic pressure supply port 125 may increase valve operating force via the magnetic force. That is, the direct control solenoid valve 120 may combine the valve operating force via the magnetic force and valve operating force via a hydraulic pressure of the hydraulic pressure supply valve 110, thereby improving responsiveness of a valve.

The control pressure supply port 123 may be opened by an operation of the second valve member 122 and may supply a control pressure input to the control pressure supply port 123 to the clutch 10 through the control pressure exhaust port 124.

A portion of a control pressure exhausted through the control pressure exhaust port 124 may be input to the switching valve 130 and may be fed back to the feedback input port 126 of the direct control solenoid valve 120. In this case, the valve operating force is increased by a hydraulic pressure input to the first hydraulic pressure supply port 125 and, thus, a feedback area (A_{f/b}_{_}_{\textcircled{2}}) via feedback pressure (P_{f/b}) fed back to the feedback input port 126 may be increased compared with a conventional feedback area (A_{f/b}_{_}_{\textcircled{1}}), thereby improving responsiveness of a valve.

In addition, the controller 140 may adjust the feedback pressure of the switching valve 130 to adjust a control pressure input to the control pressure supply port 123 of the direct control solenoid valve 120. Thereby, an operation control apparatus of a direct control solenoid valve in some forms of the present disclosure may enhance the sensitivity of a change in a control pressure with respect to a current change.

As shown in FIG. 5, the controller 140 may turn off the hydraulic pressure supply valve 110 to block a hydraulic pressure input to the direct control solenoid valve 120 and the switching valve 130 when clutch engagement is completed.

In addition, the switching valve 130 may be closed to block a feedback flow channel and a control pressure supplied to the direct control solenoid valve 120 may be totally exhausted to the clutch 10. In this case, magnetic force formed in the direct control solenoid valve 120 may be maximized and a control pressure exhausted to the clutch 10 may be maximized.

That is, when clutch engagement is completed, the switching valve 130 may be closed to block a feedback flow channel for feedback of the control pressure and to form the control pressure to be equal to a line pressure.

To this end, the controller 140 may be implemented as one or more processors that are operated by a predetermined program and the predetermined program may be programmed to perform each operation of the operation control method of the direct control solenoid valve in some forms of the present disclosure.

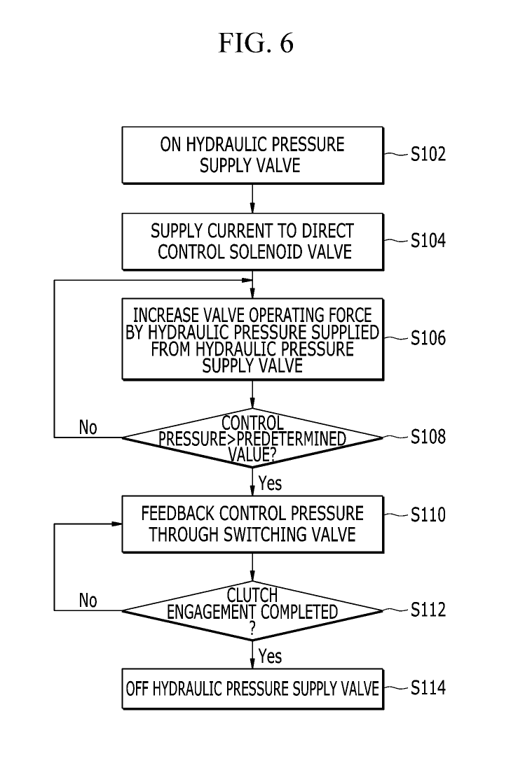

FIG. 6 is a schematic flowchart of an operation of controlling an operation of a direct control solenoid valve in some forms of the present disclosure. The flowchart of FIG. 6 will be described with regard to the configuration of FIG. 3 using the same reference numeral as in FIG. 3.

Referring to FIG. 6, the operation control apparatus of the direct control solenoid valve in some forms of the present disclosure may turn on the hydraulic pressure supply valve 110 before controlling a clutch (S102).

Current may be supplied to the direct control solenoid valve 120 to form magnetic force (S104). In this case, the first hydraulic pressure supply port 125 may be opened by an operation of the first valve member 121 and a hydraulic pressure of the hydraulic pressure supply valve 110 may be input to the first hydraulic pressure supply port 125.

A hydraulic pressure supplied to the hydraulic pressure supply valve 110 may increase valve operating force via magnetic force (S106).

When a control pressure exhausted from the direct control solenoid valve 120 is a predetermined value or more, the direct control solenoid valve 120 may feedback a control pressure through a switching valve (S108 and S110).

When clutch engagement is completed, the controller 140 may turn off a hydraulic pressure supply valve and may close the switching valve 130 to shut a feedback flow channel for feedback of the control pressure (S112 and S114).

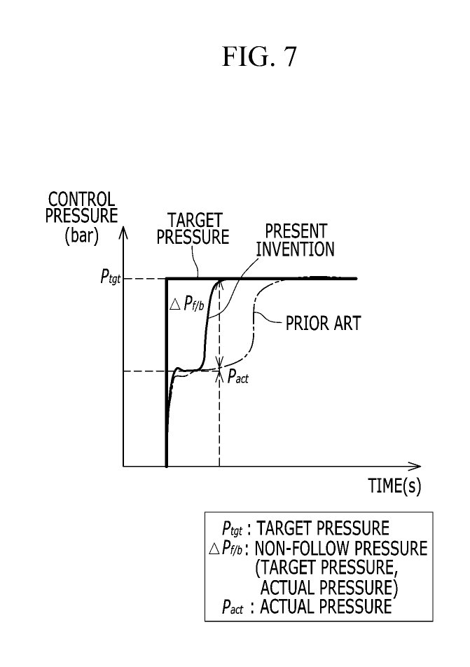

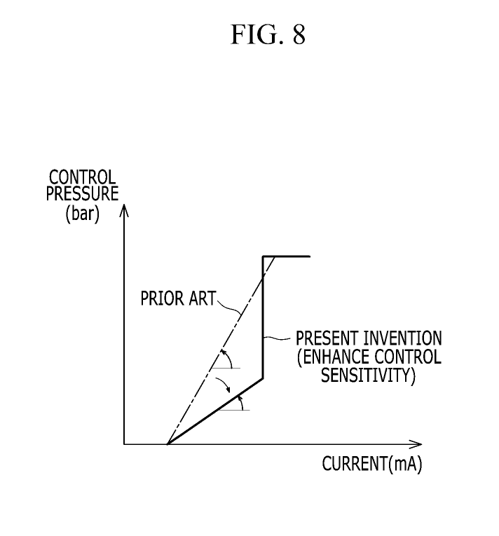

FIG. 7 is a graph showing a control pressure of an operation control apparatus of a direct control solenoid valve in some forms of the present disclosure. FIG. 8 is a graph showing a relationship between current and a hydraulic pressure by an operation of a direct control solenoid valve in some forms of the present disclosure.

As shown in FIG. 7, the operation control apparatus of the direct control solenoid valve in some forms of the present disclosure may combine valve operating force via magnetic force under current control and valve operating force via a hydraulic pressure of the hydraulic pressure supply valve 110 to rapidly make an actual control pressure (P_{act}) to be a target pressure (P_{tgt}) compared to the prior art.

That is, the operation control apparatus of the direct control solenoid valve in some forms of the present disclosure may increase valve operating force via a hydraulic pressure of the hydraulic pressure supply valve 110 to provide an environment for improving responsiveness of a valve without increase in a volume of the valve for increasing magnetic force.

As shown in FIG. 8, the operation control apparatus of the direct control solenoid valve in some forms of the present disclosure may use a switching valve to reduce a change amount of a control pressure per current and to enhance control sensitivity, thereby providing an environment for improving clutch control performance.

As such, the operation control apparatus of the direct control solenoid valve in some forms of the present disclosure may supply a hydraulic pressure to a direct control solenoid valve and a switching valve through a hydraulic pressure supply valve and may combine valve operating force from magnetic force and valve operating force from a hydraulic pressure of the hydraulic pressure supply valve to provide an environment for increasing valve operating force and for improving responsiveness of a valve without increase in a volume of the valve for increasing magnetic force.

In addition, the operation control apparatus of the direct control solenoid valve in some forms of the present disclosure may feedback a control pressure exhausted from a direct control solenoid valve to the direct control solenoid valve through a switching valve to provide an environment for remarkably enhancing the sensitivity of a change in a control pressure with respect to a current change and for improving clutch control performance.

The operation control apparatus of the direct control solenoid valve in some forms of the present disclosure may increase an area, to which a feedback pressure fed back from a switching valve is applied, by increasing valve operating force to provide an environment for enhancing responsiveness of a valve.

Some forms of the present disclosure may not be implemented by only an apparatus and a method and may be implemented via a program for performing a function corresponding to a configuration in some forms of the present disclosure or a recording medium having the program recorded thereon. The recording medium may be executed in user equipment as well as in a server.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An operation control apparatus of a direct control solenoid valve, the apparatus comprising:
a direct control solenoid valve configured to control an operation of a clutch via a control pressure and to supply the control pressure to a clutch by magnetic force generated by a current control; and
a hydraulic pressure supply valve configured to supply a hydraulic pressure to the direct control solenoid valve, wherein the hydraulic pressure supply valve is operatively associated with a clutch control.

2. The apparatus of claim 1, wherein the apparatus further comprises:
a switch valve configured to feedback the control pressure and to provide a feedback pressure to the direct control solenoid valve.

3. The apparatus of claim 2, wherein the direct control solenoid valve comprises:
a first valve member and a second valve member that are operated by valve operating force from the magnetic force;
a control pressure supply port configured to receive a control pressure by an operation of the second valve member, wherein the second valve member is configured to open the control pressure supply port; and
a control pressure exhaust port configured to supply the control pressure to the clutch.

4. The apparatus of claim 3, wherein the direct control solenoid valve further comprises:
a first hydraulic pressure supply port configured to:
receive a hydraulic pressure by the hydraulic pressure supply valve; and
increase the valve operating force that is generated from the magnetic force.

5. The apparatus of claim 3, wherein the direct control solenoid valve further comprises:
a feedback input port configured to receive a feedback pressure from the switching valve.

6. The apparatus of claim 2, wherein the switching valve comprises:
a second hydraulic pressure supply port configured to receive a hydraulic pressure by the hydraulic pressure supply valve; and
a third valve member configured to operate by a hydraulic pressure that is supplied to the second hydraulic pressure supply port.

7. The apparatus of claim 6, wherein the switching valve comprises:
a feedback input port configured to receive a control pressure that is supplied from the direct control solenoid valve, wherein the third valve member is configured to open the feedback input port; and
a feedback output port configured to feedback the control pressure to the direct control solenoid valve.

8. The apparatus of claim 2, wherein the apparatus further comprises:
a controller configured to control an operation of the direct control solenoid valve, an operation of the hydraulic pressure supply valve, and an operation of the switching valve.

9. A method of controlling an operation of a direct control solenoid valve, the method comprising:
operating a hydraulic pressure supply valve;
supplying current to the direct control solenoid valve and increasing magnetic force to operate a clutch; and
when clutch control completes, turning off the hydraulic pressure supply valve,
wherein a controller of the direct control solenoid valve is configured to control an operation of the clutch.

10. The method of claim 9, wherein operating the hydraulic pressure supply valve comprises:
standing by to supply a hydraulic pressure to the direct control solenoid valve and a switching valve.

11. The method of claim 10, wherein increasing the magnetic force comprises:
increasing valve operating force generated from the magnetic force by a hydraulic pressure that is supplied to the hydraulic pressure supply valve.

12. The method of claim 11, wherein increasing the magnetic force further comprises:
when a control pressure that is supplied to the clutch from the direct control solenoid valve is equal to or greater than a predetermined value, feeding back the control pressure to the direct control solenoid valve through the switching valve.

13. The method of claim 12, wherein turning off the hydraulic pressure supply valve comprises:
blocking a hydraulic pressure supplied to the direct control solenoid valve and to the switching valve.
